(19) United States
(12) Patent Application Publication
(10) Pub. No.: US 2008/0165934 A1
(43) Pub. Date: Jul. 10, 2008

(54) Composite Rotary-Delivery Worktable for an Air Container Detection System

(75) Inventors: Peng Hua, Guangdong (CN); Zhizhong Liang, Beijing (CN); Jinyu Zhang, Beijing (CN); Xueyou Zhou, Beijing (CN); Cong Liu, Beijing (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignees: NUCTECH COMPANY LIMITED, Beijing (CN); TSINGHUA UNIVERSITY, Beijing (CN)

(21) Appl. No.: 11/960,805

(22) Filed: Dec. 20, 2007

(30) Foreign Application Priority Data
Dec. 28, 2006 (CN) 200610169797.3

(51) Int. Cl. H05G 1/00

(52) U.S. Cl. 378/209

(57) ABSTRACT

A composite rotary-delivery worktable for use in an air container detection system, which is attached to a scanning passage of an air container diction system, said composite rotary-delivery worktable comprising a delivery assembly for carrying and delivering said air container; and a rotary assembly rotatable with a rotation axis, wherein said delivery assembly is attached to said rotary assembly such that said delivery assembly is rotatable with said rotary assembly when said rotary assembly rotates. The composite rotary-delivery worktable of this invention enables large-scale air containers to not only pass the scanning passage but also rotate freely within the scanning passage. This makes it possible to keep the scanning system fixed and stationary, thereby increasing the working reliability of the scanning system and reducing the design difficulty and complexity of the scanning system.

### FIELD OF THE INVENTION

This invention relates to a field of detecting air containers, and more particularly, to a delivery device used in an air container detection system.

### BACKGROUND OF THE INVENTION

At present, manual check and X-ray transmission detection using X-ray machine (which only small scale air containers is allowed to pass through) are still the main detecting manners in the field of detecting air cargo (for example air containers). There are also devices for detecting cargo using CT (computed tomography) technology, for example the products of Smith Company (which uses X-ray machine) and HuaLiXing Company (which uses radiation source). Relatively low penetration capacity of the X-ray machine and strict control over the use of radiation source cause many limits to use of these two kinds of products.

Especially, all these detection systems adopt a horizontal pass way of scanning to carry out CT imaging for detection. That is, the articles to be detected horizontally pass through a scanning passage, and the scanning system rotates around said scanning passage. The CT detection system that works in such a way has problems when checking relatively large scale air cargo (for example air container that is more than 2 meters in length and width, respectively). When air container is of relatively large size, the radius of the scanning passage should also be increased correspondingly. This requires that the scanning system that rotates around the scanning passage should also has relatively large radius of rotation. However, the structural design of a scanning system that has relatively large radius of rotation is difficult and complicated due to the strict limit of the structural size and penetration capacity. Further, the aforesaid CT detection system that works in a horizontal pass way of scanning requires occupying identical areas at the left and right sides of the cargo scanning passage. Therefore, such system occupies relatively large space. As a result, the present CT detection system usually cannot detect air container that is more than 2 meters in length and width. Besides, the throughput of cargo in such CT detection system is usually relatively low.

Therefore, in order to reduce the difficulty and complexity of the structural design of the scanning system, it is desirable to avoid the rotary motion of the scanning system and thus to enable the air container to rotate when it passes through the scanning passage.

### SUMMARY OF THE INVENTION

The object of this invention is to provide a composite rotary-delivery worktable for an air container detection system, which is not only capable of delivering an air container through a scanning passage but also capable of driving the air container to rotate within the scanning passage. Besides, said composite rotary-delivery worktable is preferably adapted to deliver large scale air containers.

In order to achieve the aforesaid object, this invention provide a composite rotary-delivery worktable for an air container detection system, which is installed within a scanning passage of the air container detection system. Said composite rotary-delivery worktable comprises:

a delivery assembly for carrying and delivering said air container; and

a rotary assembly rotatable about a rotary axis,

wherein said delivery assembly is attached to said rotary assembly such that said delivery assembly is rotatable with said rotary assembly when said rotary assembly rotates.

In one embodiment, said composite rotary-delivery worktable further comprises a delivery drive means for driving said delivery assembly.

In one embodiment, said delivery assembly comprises a roller delivery mechanism. Said roller delivery mechanism comprises a plurality of rollers made of a stainless steel.

In one embodiment, said delivery drive means comprises a first electrical motor for driving said roller delivery mechanism. Said composite rotary-delivery worktable further comprises a first drive-control circuit for driving/controlling said first electrical motor.

In one embodiment, said rotary assembly comprises a rotary mount onto which said delivery assembly is attached. In one embodiment, said rotary mount is a rectangular table.

In one embodiment, said delivery drive means is disposed at said rotary mount.

In one embodiment, said composite rotary-delivery worktable further comprises a rotary drive means for driving said rotary assembly. Preferably, said rotary drive means drives said rotary assembly in a gear transmission manner to rotate. In one embodiment, said rotary assembly comprises a gear ring structure, and said rotary drive means comprises a second electrical motor having a driving gear which engages said gear ring structure. In one embodiment, said rotary assembly comprises a round rotary table, said gear ring structure is arranged at the periphery of said round rotary table. In one embodiment, said rotary mount is fixedly connected to said round rotary table.

In one embodiment, said composite rotary-delivery worktable further comprises a second drive-control circuit for controlling/driving said second electrical motor to rotate for a predetermined angle or to rotate continuously.

In one embodiment, said composite rotary-delivery worktable further comprises a positioning mechanism for holding the air container in position when said air container is on the delivery assembly and is rotating. Said positioning mechanism is preferably an electrical positioning mechanism. In one embodiment, said composite rotary-delivery worktable further comprises a third drive-control circuit for controlling/driving said electrical positioning mechanism. Preferably, said positioning mechanism is disposed on said rotary mount.

Said composite rotary-delivery worktable may further comprise a base fixed on the ground of the scanning passage, said rotary assembly being disposed on said base.

In one embodiment, said composite rotary-delivery worktable further comprises a conductive slip ring for electrical connecting of said delivery assembly and said rotary assembly to exterior. Preferably, said conductive slip ring is disposed in said rotary assembly and along said rotary axis A.

The composite rotary-delivery worktable of this invention enables large scale air containers to not only pass the scanning passage but also rotate within the scanning passage. This makes it possible to keep the scanning system stationary, thereby increasing the operation reliability of the scanning system and reducing the design difficulty and complexity of the scanning system. This invention can realize straight line delivery, central rotation, positioning of container body, and precisely controlling and positioning of rotation angle. It is possible to reduce the whole size of the air container detection system by using the composite rotary-delivery worktable of this invention.

### BRIEF DESCRIPTION OF DRAWINGS

FIG. 1 is a schematic structure of a composite rotary-delivery worktable according to an embodiment of the invention;

FIG. 2 is a top view of the composite rotary-delivery worktable of FIG. 1;

FIG. 3 is a schematic block diagram of the circuit for controlling the second electrical motor;

FIG. 4 is a schematic block diagram of the circuit for controlling the first electrical motor; and

FIG. 5 is a schematic block diagram of the circuit for controlling the electrical positioning mechanism.

### LIST OF REFERENCE SIGNS

1 Base
2 Round rotary table
3 First electrical motor
4 Rotary mount
5 Roller
6 Positioning mechanism
7 Conductive multiplex slip ring
8 Second electrical motor
9 Servo controller
10 PLC
11 Encoder
12 Inverter
13 Photoelectric switch
14 Electromagnet
A Rotary axis

### DETAILED DESCRIPTION OF THE INVENTION

The following embodiments are used for describing this invention, not for limiting the scope of this invention.

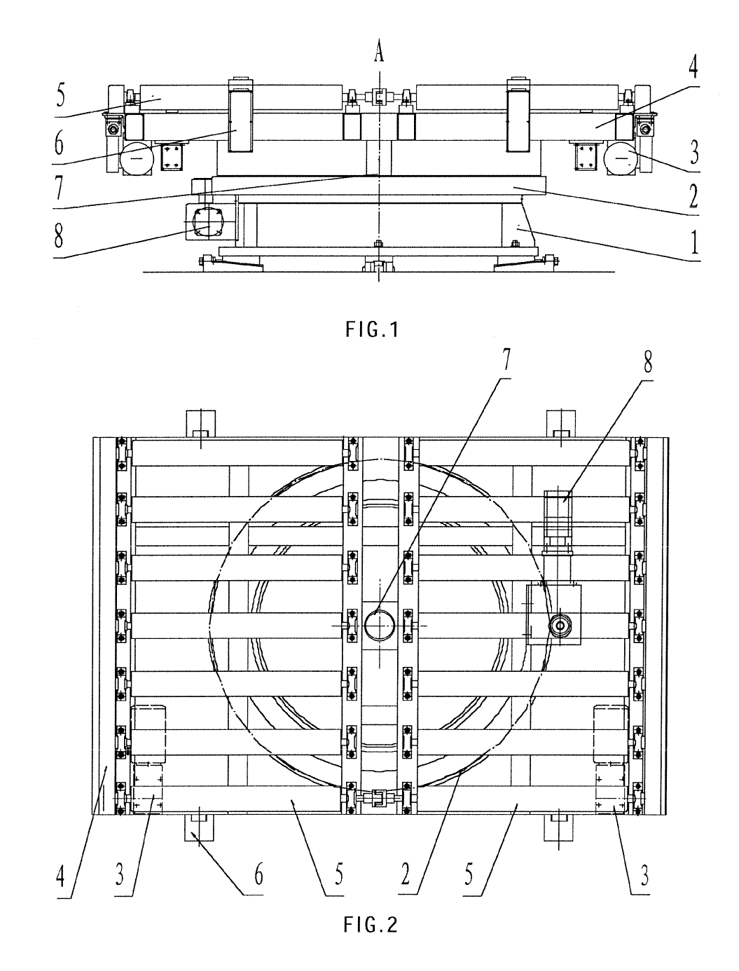

FIG. 1 and FIG. 2 show a composite rotary-delivery worktable according to an embodiment of this invention. In use, the composite rotary-delivery worktable is installed within a scanning passage of an air container detection system. As shown in FIG. 1 and FIG. 2, the composite rotary-delivery worktable comprises a rotary assembly and a delivery assembly attached to the rotary assembly.

In the shown embodiment, the rotary assembly comprises a rotary mount 4 and a round rotary table 2 which are fixedly connected to each other and rotatable about a rotary axis A. As best shown in FIG. 2, the rotary mount 4 may be a rectangular table on which the delivery assembly can be disposed, thereby meeting the operation requirements of horizontal rotation and horizontal delivery of the air container within the scanning passage. The rotary drive means for driving the rotary assembly comprises a second electrical motor 8. In one embodiment, the round rotary table 2 is provided with a gear ring structure (not shown) at its periphery. The output shaft of the second electrical motor 8 is provided with a driving gear (not shown) that engages the gear ring structure of the round rotary table 2 such that the second electrical motor 8 is capable of driving the rotary assembly in a gear transmission manner to rotate.

The delivery assembly is used to carry and deliver air containers. Further, the delivery assembly is fixedly attached to the rotary assembly and rotatable with the rotary assembly when the rotary assembly rotates. In this way, the delivery assembly is not only capable of delivering an air container, but also capable of driving the air container to rotate when the air container is on the delivery assembly.

In the shown embodiment, the delivery assembly comprises a roller delivery mechanism attached to the rotary mount 4. The roller delivery mechanism comprises a plurality of rollers 5 that may be made of stainless steel. In the embodiment as shown in FIGS. 1 and 2, these rollers 5 are arranged in two rows, but may also be arranged in other manners. When rotating, these rollers 5 define a roller plane so as to deliver an air container. The delivery drive means for driving the delivery assembly comprises a first electrical motor 3 for driving the rollers 5 to rotate. The first electrical motor 3 may also be attached to the rotary mount 4 and rotatable with the rotary mount 4. There are two first electrical motors 3 in the embodiment as shown in FIGS. 1 and 2 for synchronically driving the two rows of rollers 5, respectively.

In one embodiment, the composite rotary-delivery worktable of this invention may further comprise a positioning mechanism 6 for holding the air container in position when the air container is on the delivery assembly and rotating, thereby preventing the air container from displacing from its correct position due to translation or angular displacement. The positioning mechanism 6 is, for example, an electrical positioning mechanism. The positioning mechanism 6 may also be attached to the rotary mount 4.

The composite rotary-delivery worktable may further comprise a conductive multiplex slip ring 7 for power and/or signal transmissions between the electrical devices of the rotary and delivery assemblies, such as the first electrical motor 3 and the electrical positioning mechanism 6, and external circuits (for example, as referred to FIGS. 4 and 5). This ensures that these electrical devices can still carry out stable and reliable power and/or signal transmissions with the external circuits when they are rotating. The conductive multiplex slip ring 7 may be provided in the rotary assembly and along the rotary axis A.

The composite rotary-delivery worktable can further comprise a base 1 fixed on the ground of the scanning passage, and the rotary assembly is disposed on the base 1.

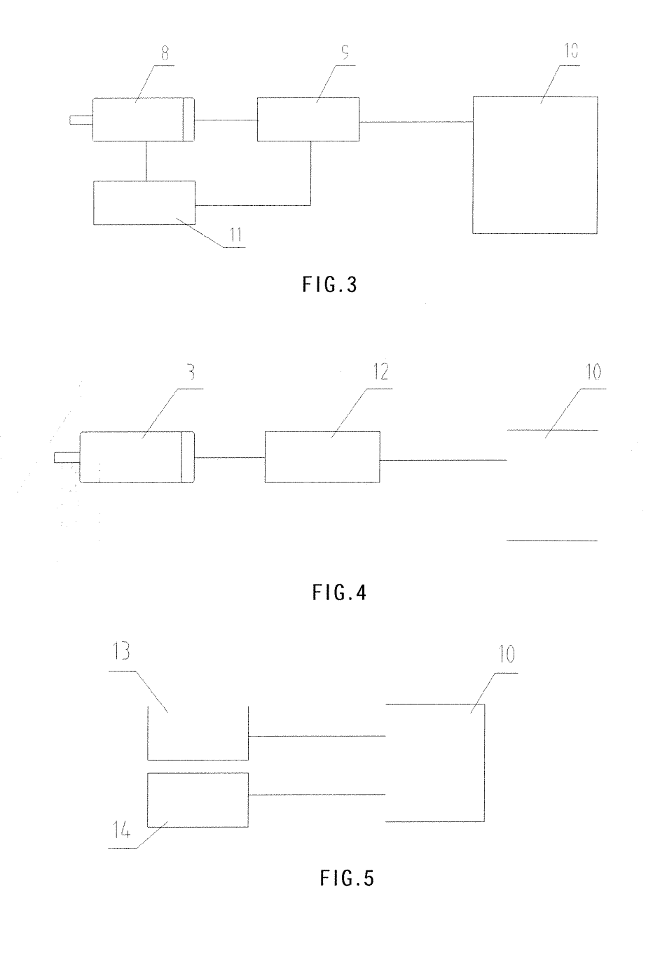

FIG. 3 shows a block diagram of a second control circuit for controlling the second electrical motor 8 in one embodiment. In this embodiment, the second electrical motor 8 is an AC servo electrical motor. A controller (such as PLC 10) sends a command to the servo controller 9. The servo controller 9 drives the second electrical motor 8 to rotate. At the same time, an encoder 11 feeds the rotation position of the second electrical motor 8 back to the servo controller 9. When the second electrical motor 8 rotates a predetermined angle to a predetermined position, the main controller 10 sends a command to cause the second electrical motor 8 to stop rotating.

FIG. 4 shows a block diagram of a first control circuit for controlling the first electrical motor 3 in one embodiment. In this embodiment, the electrical motor 3 is an AC adjustable-speed electrical motor, and a controller (such as PLC 10) controls an inverter 12 to drive the first electrical motor 3 to rotate.

FIG. 5 shows a block diagram of a third control circuit for controlling the electrical positioning mechanism 6. In this embodiment, the electrical positioning mechanism 6 comprises a positioning member made of ferromagnetic material. A photoelectric switch 13 detects whether the air container is in position and transmits a detected signal to a controller (such as PLC 10). The controller 10 controls the energizing and de-energizing of the electromagnet 14. Then, the electro-magnet 14 controls the positioning member of the electrical positioning mechanism 6 by electromagnetic force to protrude for holding an air container or to retract for releasing the air container.

Though all the controllers in FIGS. 3-5 are realized using PLC 10, it is very obvious that they may also be realized using different devices, respectively.

The composite rotary-delivery worktable of this invention has two functions. One is to deliver an air container to be detected from the entrance of the scanning passage to the exit of the scanning passage. The other is to carrying out multi-angle scanning and continuous rotary CT scanning of the air container to be detected. In operation, the rotary assembly is kept stationary at first. The delivery assembly moves the air container to be detected to a predetermined position (stop position) on the delivery assembly. Then, the delivery assembly stops delivering. Subsequently, the electrical positioning mechanism 6 rises to confine the air container in its stop position. Then, the rotary assembly starts to rotate, and brings the delivery assembly and the air container thereon to rotate in multiple angles or to rotate continuously.

These are the most preferred embodiments of this invention. Those ordinarily skilled in the art can obviously conceive of some identical or substitute solutions according to the content disclosed in this invention. However, all of them should fall into the scope of this invention.

1. A composite rotary-delivery worktable for an air container detection system, which is installed within a scanning passage of the air container detection system, said composite rotary-delivery worktable comprising:
a delivery assembly for carrying and delivering said air container; and
a rotary assembly rotatable about a rotation axis,
wherein said delivery assembly is attached to said rotary assembly such that said delivery assembly is rotatable with said rotary assembly when said rotary assembly rotates.

2. A composite rotary-delivery worktable according to claim 1, further comprising a delivery drive means for driving said delivery assembly.

3. A composite rotary-delivery worktable according to claim 1, wherein said delivery assembly comprises a roller delivery mechanism.

4. A composite rotary-delivery worktable according to claim 3, wherein said roller delivery mechanism comprises a plurality of rollers made of a stainless steel.

5. A composite rotary-delivery worktable according to claim 3, wherein said delivery drive means comprises a first electrical motor for driving said roller delivery mechanism.

6. A composite rotary-delivery worktable according to claim 4, further comprising a first drive-control circuit for driving/controlling said first electrical motor.

7. A composite rotary-delivery worktable according to claim 1, wherein said rotary assembly comprises a rotary mount onto which said delivery assembly is attached.

8. A composite rotary-delivery worktable according to claim 6, wherein said rotary mount is a rectangular table.

9. A composite rotary-delivery worktable according to claim 7, further comprising a delivery drive means for driving said delivery assembly, said delivery drive means being disposed at said rotary mount.

10. A composite rotary-delivery worktable according to claim 1, further comprising a rotary drive means for driving said rotary assembly.

11. A composite rotary-delivery worktable according to claim 10, wherein said rotary drive means drives said rotary assembly in a gear transmission manner to rotate.

12. A composite rotary-delivery worktable according to claim 11, wherein said rotary assembly comprises a gear ring structure, and said rotary drive means comprises a second electrical motor having a driving gear which engages said gear ring structure.

13. A composite rotary-delivery worktable according to claim 12, wherein said rotary assembly comprises a round rotary table, said gear ring structure being arranged at the periphery of said round rotary table.

14. A composite rotary-delivery worktable according to claim 12, further comprising a second drive-control circuit for controlling/driving said second electrical motor to rotate for a predetermined angle or to rotate continuously.

15. A composite rotary-delivery worktable according to claim 13, wherein said rotary assembly further comprises a rotary mount on which said delivery assembly is attached, said rotary mount being fixedly connected to said round rotary table.

16. A composite rotary-delivery worktable according to claim 1, further comprising a positioning mechanism for holding an air container in position when said air container is on the delivery assembly and is rotating.

17. A composite rotary-delivery worktable according to claim 16, wherein said positioning mechanism is an electrical positioning mechanism.

18. A composite rotary-delivery worktable according to claim 17, further comprising a third drive-control circuit for controlling/driving said electrical positioning mechanism.

19. A composite rotary-delivery worktable according to claim 16, wherein said rotary assembly comprises a rotary mount on which said positioning mechanism is disposed.

20. A composite rotary-delivery worktable according to claim 1, further comprising a base fixed on a ground of said scanning passage, said rotary assembly being disposed on said base.

21. A composite rotary-delivery worktable according to claim 1, further comprising a conductive slip ring for electrical connection of said delivery assembly and of said rotary assembly to exterior.

22. A composite rotary-delivery worktable according to claim 21, wherein said conductive slip ring is arranged on said rotary assembly and along said rotation axis.

23. A composite rotary-delivery worktable according to claim 2, wherein said delivery assembly comprises a roller delivery system.
